(19) United States
(12) Patent Application Publication
(10) Pub. No.: US 2020/0208763 A1
(43) Pub. Date: Jul. 2, 2020

(54) SCREW ELEMENT FOR CONNECTING PIPES AND A PIPE CONNECTING DEVICE

(71) Applicant: TI AUTOMOTIVE (HEIDELBERG) GMBH, Heidelberg (DE)

(72) Inventors: Andreas STAHN, Rauenberg (DE); Julian HOFFMANN-LEUSCHEL, Ense (DE)

(21) Appl. No.: 16/630,278

(22) PCT Filed: Jul. 11, 2018
(86) PCT No.: PCT/IB2018/055107

§ 371 Date: Jan. 10, 2020

(30) Foreign Application Priority Data
Jul. 11, 2017 (DE) 20 2017 104 112.3

(51) Int. Cl. F16L 19/028; F16L 19/02

(52) U.S. Cl. CPC F16L 19/028; F16L 19/0243

(57) ABSTRACT

A screw element for connecting pipes, preferably automotive pipes, wherein the thread is provided with a first coating in at least one area, and wherein at least one thread-free contact surface is provided with a second coating in at least one area, characterized in that the first coating comprises at least 40 wt %, preferably at least 50 wt % and especially at least 60 wt % of at least one epoxy compound, in particular at least one phenol-based epoxy compound and at least one lubricant.

### RELATED APPLICATIONS

The present document is a 35 U.S.C. § 371 national phase application of International Application No. PCT/IB2018/055107, filed on Jul. 11, 2018, which claims the benefit of priority German Patent Application No. 20 2017 104 112.3, filed Jul. 11, 2017, and entitled “Screw Element for Connecting Pipelines and a Pipe Connecting Device”, the entire contents of each of which are incorporated herein by reference.

### FIELD

The present disclosure relates to a screw element for connecting pipes, preferably automotive pipes, and a pipe connecting device wherein the thread is provided with a first coating in at least some areas, and wherein at least one thread-free contact surface is provided with a second coating in at least some areas.

### BACKGROUND

Screw elements and pipe connecting devices for pipes and/or automotive pipes are known in various embodiments from practice. In particular there are known screw elements, which are embodied as screw fittings, with which a pipe, in particular an automotive pipe, can be connected to a connecting element. These known screw fittings are normally provided with a coating, in particular an anti-corrosion coating, which usually covers the entire screw fitting.

With the screw connections known from practice, having the known screw fittings, an unwanted loosening or release of the screw connection often occurs. Such unwanted loosening/release occurs mainly with screw fittings with connected pipes, including automotive pipes in particular. When the screw fittings are screwed together, this may result in the pipe also being rotated, and due to torsion on the pipe, spring force is stored in the pipe, so to speak. The torsion of the pipe generates a reverse torque, which can result in an unwanted and/or uncontrolled loosening or release of the screw connection. Unwanted loosening or release of the screw connections may also occur in particular due to vibrations, which occur in motor vehicles in particular.

EP 2 136 119 B1 discloses a screw element of the type described above and/or a screw element according to the preamble of claim 1. These screw elements have basically proven reliable. They can nevertheless be improved further with regard to optimization of their coatings. This is also true of their abrasion properties and corrosion properties in particular.

### BRIEF SUMMARY

Accordingly, the present disclosure is based on the technical problem of providing a screw element of the type defined in the introduction which is characterized by optimized coating and by a high abrasion resistance and a high corrosion resistance. The present disclosure is also based on the technical problem of providing a pipe connecting device having such a screw element.

The present disclosure first teaches that a screw element for connecting pipes, preferably automotive pipes according to the preamble of claim 1, characterized in that the first coating comprises at least 40 wt %, preferably at least 50 wt % and especially at least 60 wt % of at least one epoxy compound, in particular at least one phenol-based epoxy compound and at least one lubricant. The screw element according to the present disclosure is especially preferably used for automotive pipes in motor vehicles. The term automotive pipe here comprises lines for fuels, for brake fluids and for refrigerants and the like.

Within the scope of the present disclosure, thread-free contact surfaces include in particular the threadless surfaces which exert a force on the corresponding mating screw element of the screw element in the case of a screw connection. This may be in particular the front end of a threaded bolt and/or a screw fitting or it may be the bottom side of a screw head of a screw element and/or of a threaded bolt.

According to a recommended embodiment of the present disclosure, the first coating has a first friction coefficient μ1 and the second coating has a second friction coefficient μ2, and the first friction coefficient μ1 is larger than the second friction coefficient μ2. One embodiment that is reliable is characterized in that the first friction coefficient μ₁ is much higher than the second friction coefficient μ₂. The friction coefficient is also known as the coefficient of friction or the friction value. It is recommended that the ratio μ₁/μ₂ of the first friction coefficient μ₁ of the first coating to the second friction coefficient μ₂ of the second coating should be between 1.1 and 5.0, more preferably between 1.1 and 4.0, preferably between 1.25 and 4.0, in particular between 1.5 and 3.5, more preferably between 1.26 and 3.5 and very preferably between 1.3 and 3.5 and/or between 1.3 and 3. According to a highly recommended embodiment of the present disclosure, the friction coefficient μ₁ of the first coating is greater than 0.1 and preferably greater than 0.15. The friction coefficient μ₂ of the second coating is preferably less than 0.08 and especially less than 0.075. The friction coefficients μ₁ and μ₂ of the first and second coatings can be adjusted by the at least one lubricant contained therein, in particular by the type and amount of this at least one lubricant. The lubricants are also specified in greater detail below.

Another embodiment of the present disclosure is characterized in that the screw element, i.e., the surface of the screw element is provided completely or substantially completely with the first coating, and the second coating is applied to the first coating in at least some areas on the at least one thread-free contact surface. It is within the scope of the present disclosure that, of the two coatings according to the present disclosure (first and second coatings), only the first coating covers the screw element over the full surface or substantially over the full surface, and only in the area of the at least one thread-free contact surface is the second coating applied to the first coating in at least some areas. Therefore, only the area of the thread-free contact surface or the at least one thread-free contact surface with respect to the two layers according to the present disclosure is designed as two layers, and only the first coating is applied in a single layer on the entire remainder or substantially the entire remainder of the screw element. It is also within the scope of the present disclosure that the screw element is provided with additional coatings beneath the first coating, in particular with at least one anti-corrosion coating and/or at least one passivation layer. For example, adhesion promoter layers may also be present. The additional layers that are preferably also provided are described in greater detail below.

According to one form of the present disclosure, the screw element according to the present disclosure is a threaded bolt or a screw fitting, which has a thread that is embodied as an external thread. This thread is then provided with the first coating, which has the first friction coefficient μ1 in particular, in at least one or more areas. It is within the scope of the present disclosure that the screw element is a screw fitting to which a pipe is connected. According to the recommended embodiment of the present disclosure, the pipe or the automotive pipe passes through the screw fitting in the axial direction and preferably engages behind the front end of the screw fitting with a pipe end. The pipe end is expediently embodied as a flange.

It is also within the scope of the present disclosure that the at least one thread-free contact surface and/or the thread-free contact surfaces of the screw element is/are oriented perpendicular or substantially perpendicular to the screw-in direction of the screw element. In the design of a screw element according to the present disclosure as a threaded bolt or as a screw fitting, the front end of the threaded bolt or the screw fitting according to the recommended embodiment of the present disclosure has a thread-free contact surface, which is coated in at least one or more areas with the second coating, which has the second friction coefficient μ2 in particular. It is also within the scope of the present disclosure that the threaded bolt or screw fitting has a screw head, and the bottom side of the screw head on the thread side has a thread-free contact surface, which is coated in at least one or more areas with the second coating, which has the second friction coefficient μ2 in particular. A very preferred embodiment of the present disclosure is characterized in that the thread-free contact surface is provided completely with the second coating on the front end of a threaded bolt or screw fitting and/or the thread-free contact surface on the bottom side of the screw head is provided completely or substantially completely with the second coating.

It is also within the scope of the present disclosure that the screw element according to the present disclosure is designed as a screw nut, which has a thread designed as an inside thread. In this case, the inside thread is coated with the first coating in at least one or more areas and preferably completely or substantially completely. The screw nut serves to receive a threaded bolt or screw fitting and preferably to receive a threaded bolt or screw fitting coated according to the present disclosure. A preferred embodiment is characterized in that the screw nut is a connecting sleeve with an inside thread for connecting two pipes or is a blind hole with an inside thread in a connecting block for a pipe to be connected. It is within the scope of the present disclosure that a contact flange of the connecting sleeve has a thread-free contact surface, which is coated with the second coating in at least one or more areas and preferably completely or substantially completely. According to one embodiment of the present disclosure, the first friction coefficient μ1 of the first coating amounts to at least 1.2 times, in particular at least 1.5 times, preferably at least two times and according to one embodiment variant, at least three times the second friction coefficient μ2 of the second coating.

It is within the scope of the present disclosure that the base body of a screw element according to the present disclosure, in particular of a threaded bolt or screw fitting according to the present disclosure, is made of metal or substantially made of metal and is preferably made of steel or substantially made of steel. This base body is expediently coated first with a zinc-nickel layer or with a zinc-nickel anti-corrosion coating. According to a recommended embodiment of the present disclosure, a passivation layer is applied to this zinc-nickel layer or zinc-nickel anti-corrosion coating. The entire screw element or substantially the entire screw element is expediently coated with both the zinc-nickel layer and the passivation layer. The first coating is preferably applied to the passivation layer, wherein the surface of the screw element or the surface of the passivation layer is provided with this first coating according to a recommended embodiment, either completely or substantially completely. It is advisable for the second coating to be applied to the first coating on the at least one thread-free contact surface of the screw element, in particular on the front end of the screw element or the screw fitting, in at least one or more areas, preferably completely.

One embodiment of the present disclosure is characterized in that the layer thickness of the second coating is greater than the layer thickness of the first coating. The layer thickness of the first coating expediently amounts to 2 to 25 μm, preferably 3 to 20 μm. It is recommended that the layer thickness of the second coating should amount to 1 to 100 μm, preferably 2 to 80 μm.

It is within the scope of the present disclosure that the first coating comprises a phenol-based epoxy compound containing at least one lubricant. It is advisable for the first coating to contain at least 40 wt %, preferably at least 50 wt % and especially at least 60 wt % of the phenol-based epoxy compound. The lubricant is expediently present in the first coating in an amount of 4 to 20 wt %, preferably 5 to 15 wt %, and especially 7 to 13 wt %, and very preferably 8 to 12 wt %. According to a preferred embodiment of the present disclosure, the lubricant in the first coating is a polymer material or an organic polymer material. The first coating preferably contains at least one lubricant from the group “polyolefin, paraffin, waxy material, polyamide, fluoropolymer.” It is recommended that the at least one polyolefin used as a lubricant should expediently be polyethylene and/or polypropylene. Polytetrafluoroethylene (PTFE) is recommended as the fluoropolymer used as a lubricant for the first coating.

It is recommended that the first coating should contain 3 to 25 wt %, preferably 4 to 20 wt %, and especially preferably 10 to 20 wt % of at least one filler material. It is within the scope of the present disclosure that multiple filler materials are present in the first coating, expediently yielding the aforementioned amount in wt % on the whole. A very preferred embodiment of the present disclosure is characterized in that the first coating contains 3 to 20 wt % aluminum, preferably 4 to 15 wt % aluminum, and especially 7 to 13 wt % aluminum.

Another embodiment of the present disclosure is characterized in that the second coating contains at least one polymer and at least one lubricant. An embodiment variant of the present disclosure is characterized in that the polymer of the second coating is an epoxy compound and in particular is a phenol-based epoxy compound. The second coating preferably contains at least one lubricant from the group “molybdenum sulfide, graphite, fluoropolymer.” The fluoropolymer may be a polytetrafluoroethylene (PTFE). It is within the scope of the present disclosure for the friction coefficient of the second coating to be adjustable through the type and quantity of the lubricant. It is recommended that the quantity of lubricant in the second coating should amount to 6 to 22 wt %, preferably 7 to 20 wt %, and especially 7 to 18 wt %. It has proven successful for the layer thickness of the second coating to be 3 to 35 μm, preferably 5 to 20 μm.

According to another form of the present disclosure, the first coating has a layer thickness of 2 to 25 μm, preferably 3 to 20 μm, and the first coating has a friction coefficient μ1 of 0.1 to 0.7, preferably 0.1 to 0.6. According to this exemplary embodiment, the second coating has a layer thickness of 1 to 100 μm, preferably 2 to 80 μm, and the second coating has a friction coefficient μ2 of 0.06 to 0.2.

The present disclosure also discloses a pipe connecting device for connecting pipes, in particular for connecting automotive pipes, with a screw element according to the present disclosure and a connecting element, wherein the screw element can be screwed together with the connecting element. It is within the scope of the present disclosure for a pipe to be connected to the screw element according to the present disclosure, and this screw element can be connected to a connecting element by a screw connection. According to a recommended embodiment of the present disclosure, the screw element is designed as a screw fitting, wherein the screw fitting has an axial bore, with a pipe passing through said axial bore. It is within the scope of the present disclosure that the pipe has a flange at one end of the pipe, and that the front end of the screw fitting which is provided with the second coating is in contact with the back side of the flange of the flange of the pipe. Fundamentally it is also within the scope of the present disclosure that the back side of the flange of the end of the pipe is provided with the second coating. The front end of the screw fitting is expediently in form-fitting contact with the back side of the flange in at least one or more areas. According to one embodiment variant of the present disclosure, the flange on the end of the pipe is an F flange, such that the rear side of the flange is arranged transversely or perpendicular to or substantially perpendicular to the longitudinal axis of the pipe. The front end of the screw fitting according to the present disclosure then has at least one surface section, which is oriented transversely or perpendicular to or substantially perpendicular to the longitudinal axis of the pipe, said surface section being in form-fitting or substantially form-fitting contact with the rear side of the flange. This surface section preferably runs over the circumference of the screw fitting. The term F flange here refers in particular to a flange having an F shape, such as that described in the DIN standard 74234. According to another embodiment of the present disclosure, the flange on the end of the pipe is an E flange, the rear side of which is designed to be conical or substantially conical. Then the front end of the screw fitting is equipped with at least one conical or substantially conical surface section, which is in form-fitting or substantially form-fitting contact with the flange rear side of the E flange. This surface section expediently runs over the circumference of the screw fitting. The term E flange here refers in particular to a flange having an E shape, such as that described in the DIN standard 74234.

The present disclosure also relates to a method for manufacturing a screw element, i.e., a screw element according to the present disclosure, wherein the screw element has at least one thread and at least one thread-free contact surface, wherein the thread is coated with a first coating in at least one or more areas, wherein at least one thread-free contact surface is coated with a second coating in at least one or more areas, and wherein the first coating comprises at least 50 wt % of at least one epoxy resin and at least one lubricant.

The present disclosure is based on the finding that unintended loosening or release of the respective screw connection can be prevented in an effective and functionally secure manner. The present disclosure is also based on the finding that the screw element, in particular a screw fitting, which has been coated with the first coating in the area of its thread, can nevertheless be screwed together easily as part of the respective screw connection. At the same time, however, this first coating subsequently prevents unintended release of the screw connection. To this extent, the first coating according to the present disclosure is characterized by very special advantages. However, the second coating applied to the first coating in the area of the contact faces reduces and/or prevents the transfer of torsional forces to the parts to be joined and/or to the pipes or pipe ends to be joined. This definitely reduces or even completely prevents a reverse torque. Within the scope of the present disclosure, the first coating is particularly important. This first coating adheres optimally to the screw element according to the present disclosure and/or to the passivation layer of the screw element. In addition to the advantages described above, this first coating additionally ensures a high abrasion resistance of the coated surfaces of the screw element as well as an optimal corrosion protection. On the one hand, the first coating, and, on the other hand, the second coating of the screw element according to the present disclosure may be coordinated with one another in an excellent manner with respect to their friction coefficients, so that the technical problem according to the present disclosure can be solved easily and efficiently. The first coating according to the present disclosure on the screw element protects the thread of the screw element mainly from mechanical damage. The first coating according to the present disclosure also has the important advantage that the force conditions on the flange of the pipe can be optimized through the adjustment of its friction coefficient, and therefore a significantly improved imperviousness and thus a greater reliability of the pipe connection can be achieved. Furthermore, the two coatings of the screw element according to the present disclosure can be applied easily and accurately to the respective surfaces of the screw element. Furthermore, the coatings according to the present disclosure can be implemented in a relatively inexpensive manner.

### BRIEF DESCRIPTION OF THE DRAWINGS

The present disclosure is described in greater detail below on the basis of drawings, which illustrate just one exemplary embodiment. In schematic diagrams:

FIG. 1 shows a longitudinal section through a pipe connecting device with a screw element according to the present disclosure in the form of a screw fitting,

FIG. 2 shows a section through a screw element according to the present disclosure designed as a screw fitting, and

FIG. 3 shows schematically the layer sequence on a screw element according to the present disclosure in the area of a thread-free contact surface.

### DETAILED DESCRIPTION

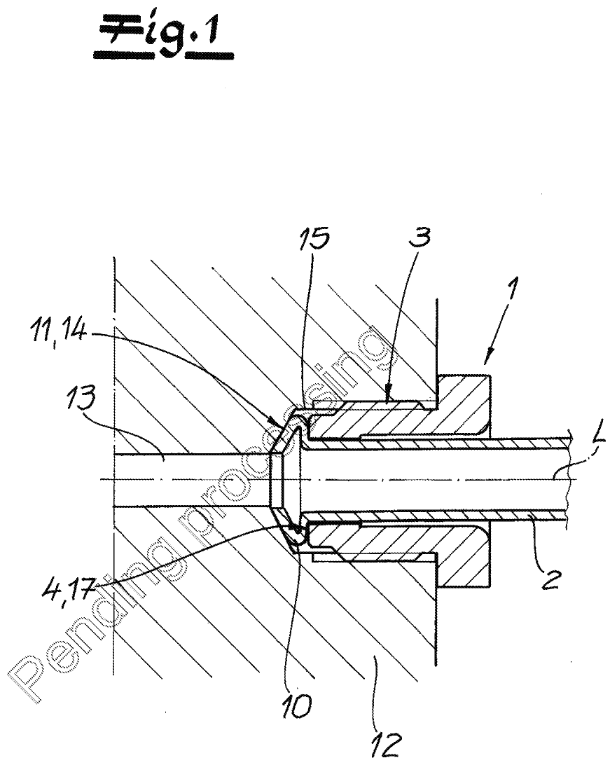

FIG. 1 illustrates a screw element according to the present disclosure, designed as a screw fitting 1 in a pipe connecting device. In this exemplary embodiment, a pipe 2 passes through the screw fitting 1 in the axial direction, and the pipe 2 has a front element on one end, designed as a flange 10. It is preferably within the scope of the present disclosure in this exemplary embodiment that this is a metal flange 10, which is preferably molded in one piece on the pipe end of the pipe 2. In this exemplary embodiment, the screw fitting 1 is screwed into a connecting element designed as a connecting block 12. Expediently and in this exemplary embodiment, the connecting block 12 here has an integrated second pipe 13. The screw fitting 1 presses the flange 10 with its front sealing surface 11 onto a connecting surface 14 of the connecting block 12. The screw fitting 1 is also screwed into a blind hole 15 in the connecting block 12 with its thread 3, which is designed as an external thread. The thread 3 on the screw fitting 1 is provided with the first coating 7 according to the present disclosure, wherein this first coating 7 preferably has a first friction coefficient μ₁. The thread-free contact surface 4 is formed on the front end of the screw fitting 1, and this thread-free contact surface 4 in this exemplary embodiment is preferably provided with a second coating 8, which preferably has a second friction coefficient μ₂. The first friction work μ₁ is larger than the second friction coefficient μ₂ in the recommended version and in the exemplary embodiment.

In the exemplary embodiment according to FIG. 1, the flange 10 of the pipe end of the pipe 2 is designed as an F flange, whose flange rear side is arranged transversely or perpendicular to the longitudinal axis L of the pipe. The front end of the screw fitting 1, which is provided with the second coating 8, has a complementary surface section 17 arranged perpendicular to the longitudinal axis L of the pipe and in form-fitting contact with the flange rear side of the F flange. In tightening the screw fitting 1, the screw fitting 1 with its thread-free contact surface 4 is pressed against the flange 10, i.e., against the flange rear side of the flange 10. Likewise, the front sealing surface 11 of the flange 10 is pressed against the connecting surface 14 of the connecting block 12. This creates a fluid-tight connection between the pipe 2 and a line 13 integrated into the connecting block 12.

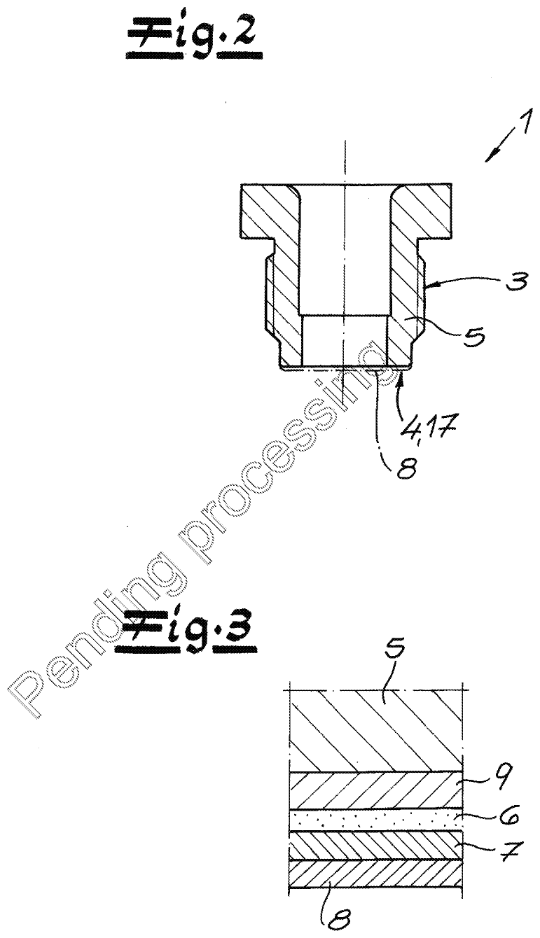

FIG. 2 shows a screw element according to the present disclosure, designed as a screw fitting 1. As already explained above, this screw fitting 1 has a thread 3 and a thread-free contact surface 4 on its front end. The thread 3 is coated with the first coating 7 having the first friction coefficient μ₁ and is preferably coated completely, i.e., on the complete circumference in this exemplary embodiment. In the recommended version and in the exemplary embodiment, the entire screw fitting 1, i.e., the entire surface of the screw fitting 1 is first provided with the first coating 7 having the first friction coefficient μ₁. In this exemplary embodiment, the second coating 8 with the second friction coefficient μ₂ on the thread-free contact surface 4 on the front end of the screw fitting 1 is preferably applied to the first coating 7. The first friction coefficient μ₁ of the first coating 7 here is expediently greater than the second friction coefficient μ₂ of the second coating 8.

FIG. 3 illustrates a very preferred layer sequence for the coating of the screw element or screw fitting 1 according to the present disclosure, namely in the area of the thread-free contact surface 4 on the front end of the screw fitting 1. First, a zinc-nickel layer or a zinc-nickel anti-corrosion coating 9 is applied to the base body 5, i.e., to the metallic base body 5 of the screw fitting 1. The entire screw element or screw fitting 1 according to the present disclosure is preferably provided with this zinc-nickel anti-corrosion coating 5. According to the preferred embodiment of the present disclosure and in the exemplary embodiment, a passivation layer 6, which is expediently arranged on the entire surface of the screw fitting 1 or on the zinc-nickel anti-corrosion coating 9, is provided on the zinc-nickel anti-corrosion coating 9. In this exemplary embodiment, the first coating 7 according to the present disclosure, having the first friction coefficient μ₁, is preferably applied to the passivation layer 6, in particular over the entire surface of the screw fitting 1. In the area of the thread-free contact surface 4 on the front end of the screw fitting, the second coating 8 having the second friction coefficient μ₂ in this exemplary embodiment is expediently applied to the first coating 7 having the first friction coefficient μ₁. In the exemplary embodiment according to FIG. 3, the base body 5 of the screw element or the screw fitting 1 according to the present disclosure is thus provided with a total of four layers in the area of the thread-free contact surface 4 on the front end of the screw fitting 1, namely the zinc-nickel anti-corrosion coating 9, the passivation layer 6, the first coating 7 and the second coating 8.

1. A screw element for connecting pipes, wherein the screw element has at least one thread and at least one thread-free contact surface, wherein the thread is provided with a first coating in at least one area, wherein the at least one thread-free contact surface is provided with a second coating at least one area, and wherein the first coating comprises at least 40 wt % and at least one lubricant.

2. The screw element according to claim 1, wherein the first coating has a first friction coefficient μ₁, and the second coating has a second friction coefficient μ₂, wherein the first friction coefficient μ₁ is greater than the second friction coefficient μ₂.

3. The screw element according to claim 1, wherein the ratio of the first friction coefficient μ₁ of the first coating to the second friction coefficient μ₂ of the second coating (μ₁/μ₂) is between 1.1 and 4.0.

4. The screw element according to claim 1, wherein a surface of the screw element, is provided substantially completely with the first coating, and the second coating is applied to the first coating in the at least one area of the at least one thread-free contact surface.

5. The screw element according to claim 1, wherein the screw element is a threaded bolt or a screw fitting, which has a thread configured as an external thread.

6. The screw element according to claim 5, wherein a front end of the threaded bolt or the screw fitting has the at least one thread-free contact surface, which is coated with the second coating in the at least one area.

7. The screw element according to claim 1, wherein the layer thickness of the first coating is 2 to 25 μm.

8. The screw element according to claim 1, wherein the lubricant in the first coating is a polymer material and the at least one lubricant is selected from the group of polyolefin, paraffin, waxy material, polyamide, and fluoropolymer.

9. The screw element according to claim 1, wherein the lubricant is present in the amount of 4 to 20 wt % in the first coating.

10. The screw element according to claim 1, wherein the first coating contains 3 to 25 wt %, of at least one filler material.

11. The screw element according to claim 1, wherein the layer thickness of the second coating is 1 to 100 μm.

12. The screw element according to claim 1, wherein the layer thickness of the second coating is greater than the layer thickness of the first coating.

13. The screw element according to claim 1, wherein the second coating comprises at least one polymer and at least one lubricant.

14. The screw element according to claim 1, wherein the second coating contains at least one lubricant selected from the group of molybdenum sulfide, graphite, and polytetrafluoroethylene.

15. The screw element according to claim 1, wherein the first coating contains 3 to 20 wt % aluminum.

16. The screw element according to claim 1, wherein the screw element is coated with at least one anti-corrosion coating arranged beneath the first coating.

17. The screw element according to claim 1, wherein at least one passivation layer is applied to the screw element, wherein the passivation layer is arranged beneath the first coating, and wherein the passivation layer is arranged between the anti-corrosion coating and the first coating.

18. A pipe connecting device for connecting pipes having a screw element according to claim 1, wherein a pipe is connected to the screw element and wherein the screw element is configured for connection to a connecting element by means of a screw connection.

19. The pipe connecting device according to claim 18, wherein the screw element is a screw fitting with an axial bore, said axial bore having a piped passing therethrough, wherein the pipe has a flanged on its pipe end, and wherein the thread-free contact surface of the screw fitting, which is provided with the second coating, is in contact with the flange.

20. The screw element according to claim 1, wherein the first coating comprises at least 50% wt of at least one epoxy compound, and wherein the at least one epoxy compound is a phenol-based epoxy compound.
